(19) United States
(12) Patent Application Publication
(10) Pub. No.: US 2004/0049685 A1
(43) Pub. Date: Mar. 11, 2004

(54) Authorisation method for a user of a limited access system having an authorisation centre

(76) Inventor: Laszlo Jaloveczki, Budapest (HU)

Correspondence Address: Welsh & Katz, Ltd., 22nd Floor, 120 South Riverside Plaza, Chicago, IL, 60606, US

(21) Appl. No.: 10/658,345

(22) Filed: Sep. 9, 2003

Related U.S. Application Data
(63) Continuation of application No. PCT/HU01/00105, filed on Oct. 30, 2001.

(30) Foreign Application Priority Data
Mar. 14, 2001 (HU) P 0101106

(51) Int. Cl. H04L 9/00

(52) U.S. Cl. 713/182

(57) ABSTRACT

The method enables the authorisation centre of a limited access system to determine whether a user desiring to gain access to the system via a remote terminal having local processing capacity is authorised to gain access or not, to authenticate the sender and verify the content of any information claimed to be sent by a user via a remote terminal and to ensure that any information sent by the authorisation centre to a user via a remote terminal may be accessed only by the user and may not be accessed by any unauthorised third person. The method is built upon the creation of one-time cryptographic keys and unique cryptographic algorithms in parallel at the authorisation centre and at the remote terminal using a common graphical symbol set generating algorithm known to the authentication centre and to the user plus a common cryptographic key generation algorithm and a common cryptographic algorithm generation process known to the authorisation centre and to the remote terminal.

### BACKGROUND OF THE INVENTION

1. Field of the Invention

The invention relates to an authorisation method for an enrolled user of a limited access system presenting himself at a remote location to obtain access to the system, wherein the system has an authorisation centre and the remote location is provided with a remote terminal connected to the system.

2. Description of the Prior Art

When creating a limited access system to be accessed by a large number of authorised users communicating with the system through a large scale computer network such as the Internet the system has to be equipped

a) to give access to the system to all authorised users and to prevent any unauthorised person from gaining access and

a) to verify the senders and the content of any information (codes, money transfers, buying orders, etc) claimed to be sent by the authorised users and the receiver and the content of any information sent to the authorised users.

According to existing practice, whenever a person wishes to gain access to a limited access system, he communicates his user identification code to the system (by inserting his plastic card into a reader, by entering the code via a keyboard, etc.). The system verifies whether this code is existing and valid. If the user identification code is correct, the user is generally asked to enter his password or personal code into the computer. This is compared with the password or personal code stored in the computer. Only if both are identical does the security system permit access. Such user identification codes can take various forms, such as the known magnetic card, a smart card, a figure-letter combination, a fingerprint template, etc. In general both the user identification code and the password or personal code are static and they are fixed at least for a limited period of time.

A number of methods are known, where at each trial to gain access to the system the password/personal code of the user is modified according to a predefined method. Examples of such systems are

a) a limited access system where the result of an operation between a system generated random number and a personal code is entered as the password into the system,

b) a limited access system where an alphanumerical access key and a ciphering method are assigned to the user, plus the system and the user agree on using some non-system generated dynamic variable. When the user wishes to gain access to the system, he has to enter the result of the ciphering method performed on the user's access key with the current value of the dynamic variable,

c) a limited access system where the user possesses an identification device which, on the basis of a random number issued by the system and subsequently entered in said identification device, calculates a password on the basis of a pre-programmed function,

d) a limited access system where the user is assigned a mathematical function F plus a personal code consisting of two parts, part I defining some positions in a series of random figures and part X being (a) number(s). When this user wishes to gain access to the secured system, a series of random figures are communicated to the user who has to enter a series of digits created by applying the function F digit by digit on the digits of the random series being located at the positions shown by part I of his personal code and on the number(s) X making the second part of his personal code.

Beside the control of the access to a limited access system it is frequently the case that confidential or proprietary information must be passed electronically from one location to another. Such electronic communication is easily susceptible to interception if not protected in some form in addition to access protection.

Generally the verification of the identity of the sender and/or the receiver and the integrity and privacy of the content of the communicated information are secured by the application of some form of cryptography. Cryptographic processes are based on cryptographic keys. One of the main categories of cryptographic methods is the group of symmetric key methods. However, for two persons to communicate successfully using symmetric keys, each must use the same key or inverse keys to encrypt the message.

One of the main subcategories of symmetric key cryptosystems is the category of Block-Cipher algorithms which may be further divided into subcategories such as Electronic Code Book (ECB), Cipher Block Chaining (CBC), Cipher-Feedback (CFB), Output-Feedback (OFB) processes.

To perform any encryption-decryption based on symmetric keys, two persons must possess compatible cryptographic equipment, and they must also have identical keys. Further, those keys must be kept secret from anyone not in a position of confidence with the two communicators and must be changed periodically to guard against compromise.

One particular symmetric key system is known as the data encryption standard or “DES”, which is published by the National Institute of Science and Technology. The DES was originally specified for the encryption of sensitive government information unrelated to national security. The DES uses a sixty-four byte key, fifty-six of which are independent bytes and eight bytes which may be used for parity checking. The DES was first publishing in January 1977 in FIPS-PUB-46, which is available from the National Technical Information Service.

Some symmetric key management systems are known to exist where cryptographic keys are not exchanged but generated both at the sender and the receiver based on a common algorithm using the date or the time of the day as a dynamic variable.

The second main category of cryptographic methods has evolved to overcome many of the above problems. The public key cryptography system employs two separate keys for encryption and decryption of messages or data. One of the keys is private and only held by its owner. The other key is public, that is, available to everyone within the network. All information sent to a person are encrypted by this person's public key. This information feasibly may be decrypted only by using the same person's private key. To verify the person of the sender of a message the message is encrypted by using the private key of the sender. In this case the original form of the information may only be regained by decrypting it with using the sender's public key which fact also proves the authenticity of the sender.

The computational need of the symmetric key systems' is low and they are easy to use, however it is a serious disadvantage that the keys shall be changed and exchanged periodically.

The security of the public key systems is very high and the problem of key exchange is eliminated, however the computational need of such systems is extremely high.

It is a common disadvantage of both systems that the cryptographic keys used by them are too long to be remembered by any person therefore the keys have to be stored on the hard disk of a computer or in an other information storing device such as a chip card, etc. Therefore these systems provide the verification of a computer or a token, rather than that of a physical person.

### BRIEF SUMMARY OF THE INVENTION

As most of the presently used methods of user identification from remote terminals are either low security or impractical it is the primary object of the present invention to create a secure access control system based upon one-time passwords (cryptographic keys) generated in the same time by a user at the remote terminal and by the authorisation centre of a limited access system without exchanging keys, so that the generation of the cryptographic keys be so simple for the user that it does not require any tool or device.

As there is no highly secure and low computational need method to verify the physical person of the sender and the integrity of the content of a message sent by a user to a limited access system from a remote terminal an additional object of the present invention is to provide a cryptographic system to use the independently generated one-time symmetric keys (passwords) for the authentication of any message sent by a user to the limited access system or by the system to the user.

Therefore the objects of the present invention are parts of a method that enables the authorisation centre of a limited access system to determine whether a user desiring to gain access to the system via a remote terminal having local processing capacity is authorised to gain access or not and if yes whether any message claimed to be sent by this user to the authorisation centre via the remote terminal is really sent by this user:

At the time of enrolment the authorisation centre provides the user with a list of basic graphical symbol selection and modification algorithms from which algorithms the user may select one or more.

From the selected basic algorithms the user may build a simple or complex symbol set generating algorithm.

The algorithm built by the user is stored by the authorisation centre and by the user together with a unique user identification symbol/number/character chain.

When access is desired the authorisation centre provides the user with an arrangement of randomly selected graphical symbols of different features and the user generates and subsequently enters to the remote terminal a set of symbols formed by using the symbol set generating algorithm built by him and the arrangement of randomly selected graphical symbols provided by the authorisation centre.

A feature of a graphical symbol may be any feature by the changing of which two otherwise identical graphical symbols may be differentiated (such as size, colour, direction, movement, attached voice or sound, etc.).

The terminal through which the user desires to gain access to the limited access system generates a one-time cryptographic key from the set of graphical symbols generated by the user according to a specific method also known to the authorisation centre and with this newly generated key encrypts the user's login message by using a unique cryptographic algorithm also known to the authorisation centre.

The cryptogram is sent to the authorisation centre together with the user's identification number/symbol. Upon receiving the encrypted message and the user's identification number/symbol from the remote terminal, the authorisation centre also generates the corresponding set of symbols based on the same arrangement of randomly selected graphical symbols and on the symbol set generating algorithm stored together with the user identification number/symbol attached to the cryptogram.

Using the same encryption key generating algorithm and unique cryptographic algorithm as the remote terminal, the authorisation centre makes a try to decrypt the message. If the decryption results in a message fulfilling certain conditions known to the remote terminal and to the authorisation centre (for example only consist of normal alphanumeric characters or a pre-agreed key word is attached to the text, etc), the user is authorised to gain access to the system and the message is accepted to be sent by the user; if not then access is denied and the message is not accepted to be authentic.

The same encryption-decryption procedure is repeated by all messages sent by the user and at appropriate time intervals or upon the occurrence of predefined events a new encryption key and a new cryptographic algorithm is generated using a new arrangement of randomly selected graphical symbols provided by the authorisation centre.

As additional security, before sending any information to any particular user, the authorisation centre may use the user's symbol set generating algorithm, it may generate a symbol set from which it may further generate the corresponding cryptographic key and a unique cryptographic algorithm and may encrypt the information to be sent with the new cryptographic key and the new unique cryptographic algorithm. The message may be sent to the user together with the arrangement of graphical symbols used to generate the key, and the user may regain the original message only if he generates the same symbol set and therefore the same cryptographic key and cryptographic method.

The same method may be used with the modification that the remote terminal—when access is desired—first sends the user's user identification number/symbol to the authorisation centre and upon receiving this identification number/symbol the authorisation centre provides an arrangement of graphical symbols selected to fit best to the symbol set generating method stored together with the received user identification number/symbol.

### BRIEF DESCRIPTION OF THE SEVERAL VIEWS OF THE DRAWINGS

The invention will now be described in connection with preferable embodiments thereof with reference to the accompanying drawings. In the drawing:

FIG. 1 shows the general block diagram of the authorisation system;

FIG. 2a is a flow chart showing the function of a first embodiment of the invention;

FIG. 2b is a flow chart showing the function of a second embodiment of the invention;

FIG. 2c is a flow chart showing the function of a third embodiment of the invention;

FIG. 2d is a flow chart showing the function of a fourth embodiment of the invention;

FIG. 2e is a flow chart showing the function of a fifth embodiment of the invention; and

FIG. 3 is a pictorial representation of a typical screenplay for use by a user.

### DETAILED DESCRIPTION OF THE INVENTION

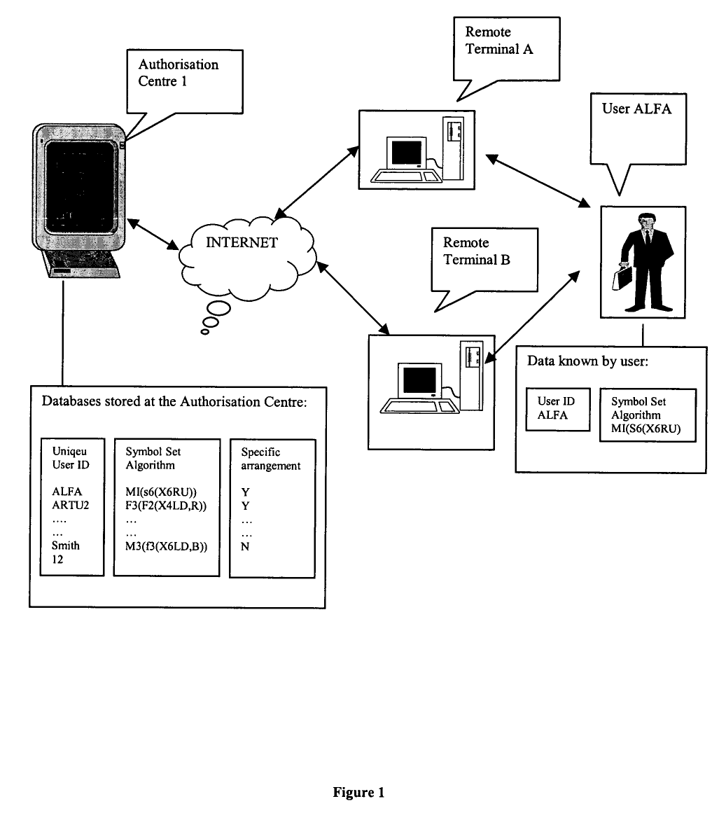

The system shown in FIG. 1 provides a strictly controlled bi-directional data connection between a user ALFA who can be at any one of several remote terminals and an authorisation centre 1 which is typically a computer with data storing and processing capacity.

The authorisation centre 1 keeps a database of a predetermined number of basic graphical symbol selection and/or modification algorithms. A basic graphical symbol selection algorithm is an algorithm, which generates one or more graphical symbol(s) as output from a multiplicity of graphical symbols as input. A basic graphical symbol modification algorithm is an algorithm, which generates a graphical symbol as output from another graphical symbol(s) as input. A complex graphical symbol set generating algorithm is a multiplicity of simple graphical symbol selection and modification algorithms to be performed one by one according to the result of the previous operation.

A graphical symbol may be the visual representation of any object, person, form, shape, idea, concept—including numbers, letters and signs—or anything else what may be visually represented. In addition to the basic visual appearance a graphical symbol can have different further features. Such further feature of a graphical symbol may comprise any property by the changing of which two graphical symbols of the same form may be distinguished (such as size, colour, pattern, direction, movement, attached voice or sound, etc.).

The authorisation centre 1 keeps a further database of user identification codes or in short user ID's which can be in combination numbers, symbols, character chains, etc. Within the authorisation centre 1 each user is uniquely identified by an associated ID.

Linked to the user ID database the authorisation centre 1 also comprises a further database storing symbol set generating algorithms. In the database each user ID is associated with a predetermined graphical symbol set generating algorithm. The graphical symbol set generating algorithms are, however, not unique and may be assigned to different users.

The assignment of user ID-s and symbol set generating algorithms may occur by a system administrator that can either be a natural person or an automated assignment system. The user may interactively participate in creating his graphical symbol set generating algorithm. The users may change their graphical symbol selection algorithms any time they wish to do so.

The authorisation centre 1 stores furthermore an algorithm capable of generating a cryptographic key of a certain length from any set of graphical symbols that have the same or smaller length.

It is preferable but not always required that different multi-digit numbers represent the different graphical symbols. In such a case the cryptographic key generating algorithm may be any kind of message digest function. Message digest functions are known in the art of cryptography, and they are capable of generating a unique cryptographic key of predetermined length from every multi digit number of much longer length so that one cannot retrieve the multi digit number from the generated key.

Besides the cryptographic key generating algorithm the authorisation centre 1 can also store a cryptographic algorithm generating process used to generate the unique encryption algorithms which are further used for encrypting and decrypting messages sent or received by a remote terminal. Such cryptographic algorithms generated can be variables of different symmetric key algorithms (ECB, CBC, CFB, OFB).

As a further means of security, the authorisation centre may also store a higher level encryption algorithm, which may be a symmetric key algorithm or a combined public key and symmetric key algorithm. Typical representations of such high level symmetric key algorithms are the conventionally known DES and Triple DES algorithms. A typical example for the combination of a public key and symmetric key method is encrypting the original message with a symmetric key using DES algorithm at the remote terminal. When this step is completed, the symmetric cryptographic key is encrypted by using the public key of the authorisation centre 1. The original message may be recovered by decrypting the cryptogram of the symmetric key by the private key of the authorisation centre and decrypting the message with the newly decrypted symmetric key.

As a means to decrease the processing need associated to the encryption-decryption of the whole message of the user, it is possible to create a digital fingerprint (message authentication code, MAC) from the message and to encrypt and decrypt only the digital fingerprint while the message may be transferred unencrypted. This method alone does not provide for the privacy of the message, however authenticates the person of sender, the receiver and the integrity of the message. A digital fingerprint is a chain of alphanumeric characters generated from a file or text by a one way hash function (for example MD5). The main characteristic of a one way hash function is that it is easy to create a character chain from a text or a file but it is extremely difficult or impossible to regain the text or the file from the character chain. As the one way hash functions generate very different character chains from slightly different texts (more than 50% of the characters in a character chain are different if one letter is different in an entire page of text) they may be used to control the integrity of a file or a text transferred via the Internet. An algorithm to create a digital fingerprint from a message (for example MD5) may be stored both in the authentication centre and on the remote terminal.

A remote terminal is typically a computer with temporary data storage and data processing capacity.

The remote terminal either stores an algorithm generating a cryptographic key of a certain length from any set of graphical symbols, or receives it from the authorisation centre each time a user wishes to gain access to the system. In the examples such cryptographic key generating algorithm are the same as those defining the algorithms stored by the authorisation centre.

The remote terminal either stores a cryptographic algorithm encrypting and decrypting messages to be sent by the user to the authorisation centre, or receives it from the authorisation centre each time a user wishes to communicate with the authorisation centre or stores a cryptographic algorithm generating process also known to the authorisation centre by means of which it generates a unique cryptographic algorithm from each set of graphical symbols selected by the user. It is preferable if such cryptographic algorithm is the same as the algorithms stored or generated by the authorisation centre.

A user is typically a natural person with average sensory and cognitive capacity who wishes to gain access to the services of a limited access system. The user shall store or know his unique identifier or ID and the graphical symbol set generating and/or modification algorithm stored at the authorisation centre in the symbol set generating algorithm database associated with his ID. Such an algorithm is generally a few of specific geometrical or selection rules, which the user can easily memorise.

Typically, the authorisation centre and the remote terminal are connected to each other via a wide area network of extreme dimensions—such as the INTERNET—and they are communicating with each other using common communication protocols such as TCP/IP. The physical means of communication may be any method capable of transferring digital data from one geographic location to another such as telephone lines, optical cables, satellites, broadcasting, etc.

The main means of communication between the remote user and data authorisation centre can be the Internet.

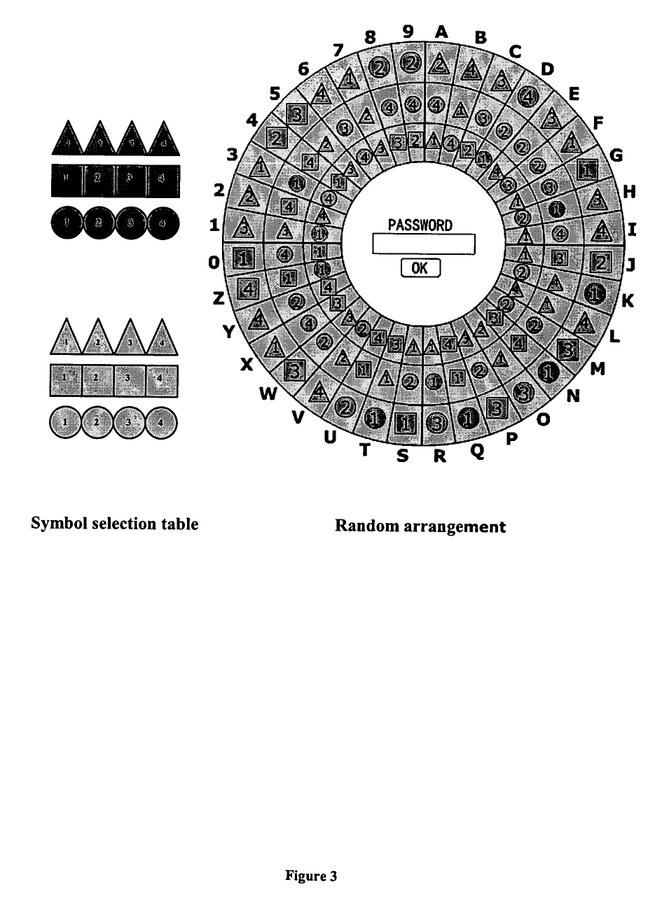

FIG. 3 shows a pictorial representation of a typical screenplay used by the user to perform the user's symbol set generating task in a preferred embodiment of the invention. Such a screenplay is displayed to the user at the remote terminal.

In this embodiment the user's ID consists of an alphanumeric character chain. The graphical symbol set of the user consists of at least three graphical symbols that has to be selected as well. In this example the graphical symbols used are basic geometric shapes (such as regular triangle, square and circle). Each basic graphical symbol of a definite form and shape may be further characterised by two further selection criterions i.e. one of two colours and one of four numbers written on the objects.

The selection of any particular symbol can take place by

a) using the object selection table shown at the left field of the screen, which determine twenty four different symbols categorised by their basic shape e.g. rectangle, triangle, circle etc., their colour and the number written on them (the user has to use the mouse or the arrows on the keyboard and the enter at any line),

b) using the random arrangement of graphical objects (the user may use the mouse to click on any symbol or on any alphanumeric character shown at the side of each radius to select a group of symbols),

c) using the keyboard to enter any alphanumeric characters identifying groups of symbols

and when the selection criterion is met, he can press the OK button or the enter key. Any wrong selection may be repeated after using the cancel key on the keyboard. The significance of the suggested way of symbol selection lies in that humans can well memorise complex shapes including the listed features, and by doing this a comparatively small amount of symbol set elements can represent a huge choice, of which the required selection represents only a single possibility, and it is practically impossible for anyone to find it out without the knowledge of the selection criteria of the user.

In this specific embodiment the number of basic graphical symbols is three, each being represented by one of two possible colours and one of four possible numbers being written on them. As there are 108 symbols in the random arrangement, 36 alphanumeric characters at the end of the radiuses plus the user may enter any of the 36 alphanumeric characters also by using the keys of the keyboard, the total number of different three click selections is ((3*2*4=24)+108+36+36=204)³=8′489′664.

The user shall identify himself by an alphanumeric character chain. As the number of different character chains is unlimited, in this embodiment the number of users of the system is theoretically not limited.

In this preferred embodiment the arrangement of graphical symbols provided by the authorisation centre to the user shall be three concentric circles containing 36 graphical symbols each.

In the preferred embodiment the graphical symbol selection algorithms shall consist of subtypes

a) selecting graphical symbol(s) by location (SL), with variants of absolute location related to a starting symbol and relative location related to an other graphical symbol, or

b) selecting the first, second, etc. graphical symbol by form or feature (colour, shape, number written on the object or the result of a comparison of two symbols). The scope and direction of the selection shall be provided (the whole arrangement, from the starting symbol to one location, from one location to an another location, from one location to the ending symbol), searching from the direction of the starting symbol toward the ending symbol or from the direction of the ending symbol toward the starting symbol.

In this preferred embodiment the graphical symbol modification algorithms shall consist of algorithms changing one form or feature at a time to another specific form or feature (such as changing any shape to a predetermined shape, changing any colour to a predetermined colour, changing any pattern to a definite pattern).

As an example, the complex graphical symbol selection algorithms may include any of the following commands:

Select the last two red symbols anticlockwise in the third quarter of the second and third circles, select the first symbol with a 4 digit written on it in the first circle clockwise selected from the radius signed by the character 1, select the symbols of the second and third circle located on the same radius as the first red symbol in the first circle selected from the radius signed by the character q clockwise, select the symbols being located immediately bellow, above and to the direction of the clock of the first green symbol in the second circle selected in clockwise direction from the radius signed by the character g, etc.

With these selection algorithms one may provide 204*204*204=8′489′664 different sets of three mouse clicks or key hits from any given random arrangement consisting of 3 concentric circles of 36 symbols.

As any set of three mouse clicks or key hits may be reached by many different symbol selection algorithms (the same symbols may be found on different selection criteria and from different directions) therefore the number of applicable symbol selection operations is higher by magnitudes.

It should be understood that the implementation of other variations and modifications of the invention in its various aspects will be apparent to those of ordinary skill in the art, and that the invention is not limited by the specific embodiments described. The present examples were given only for the illustration how easy thoughts lie behind the sophisticated definitions used hereinabove.

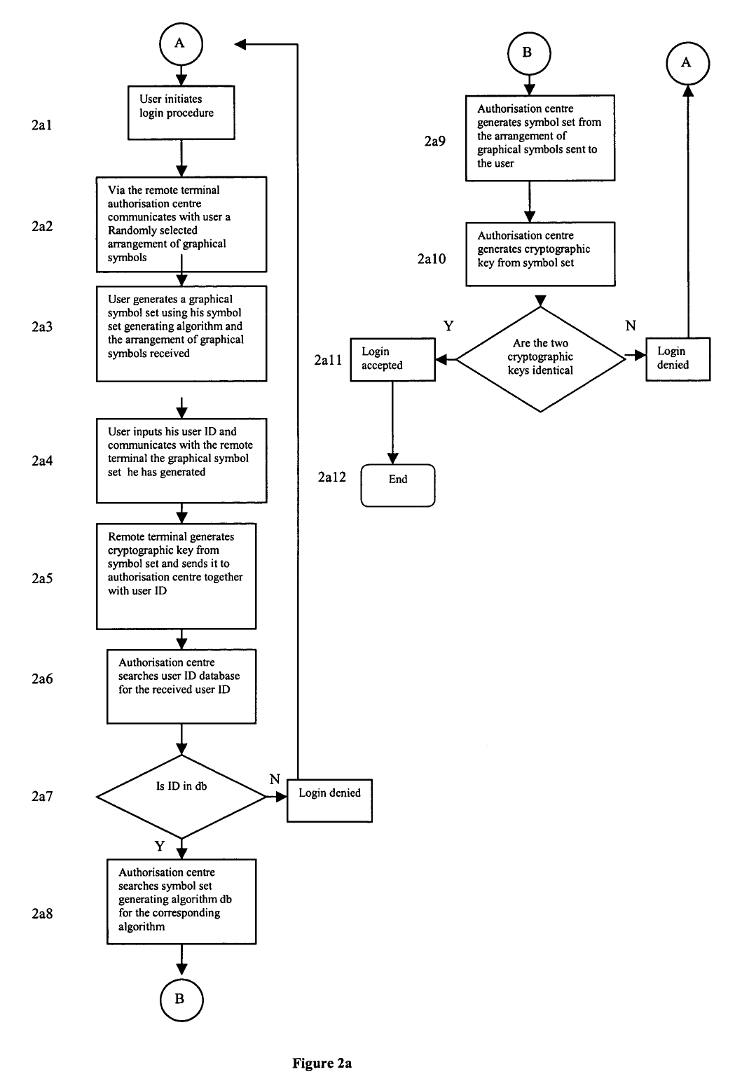

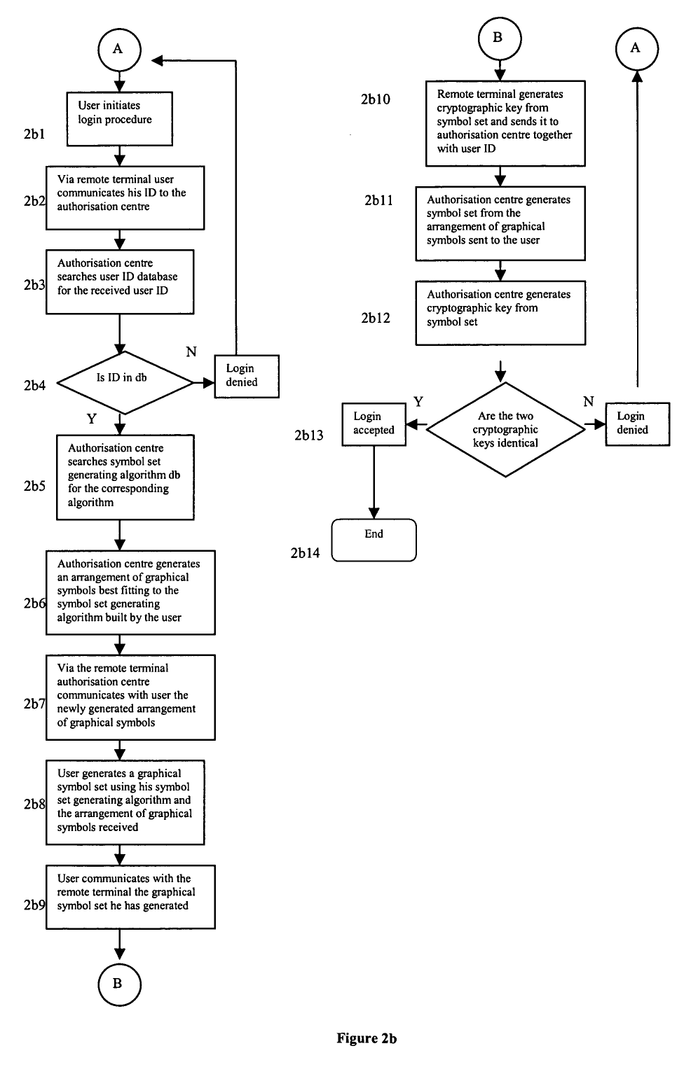

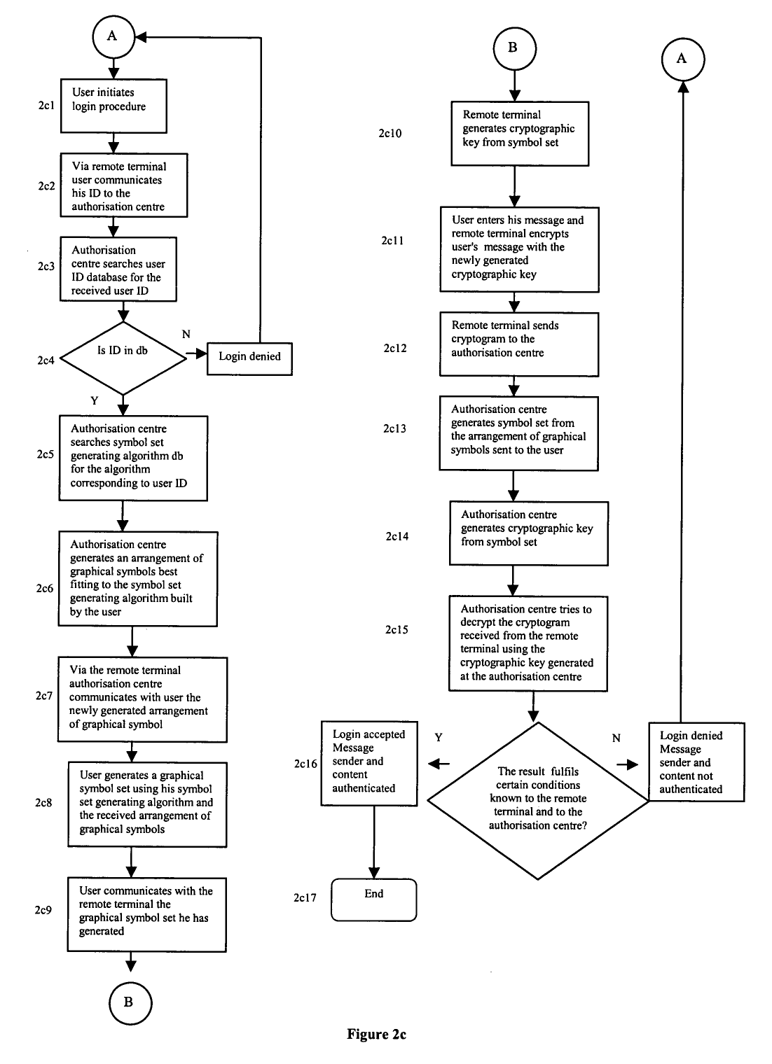

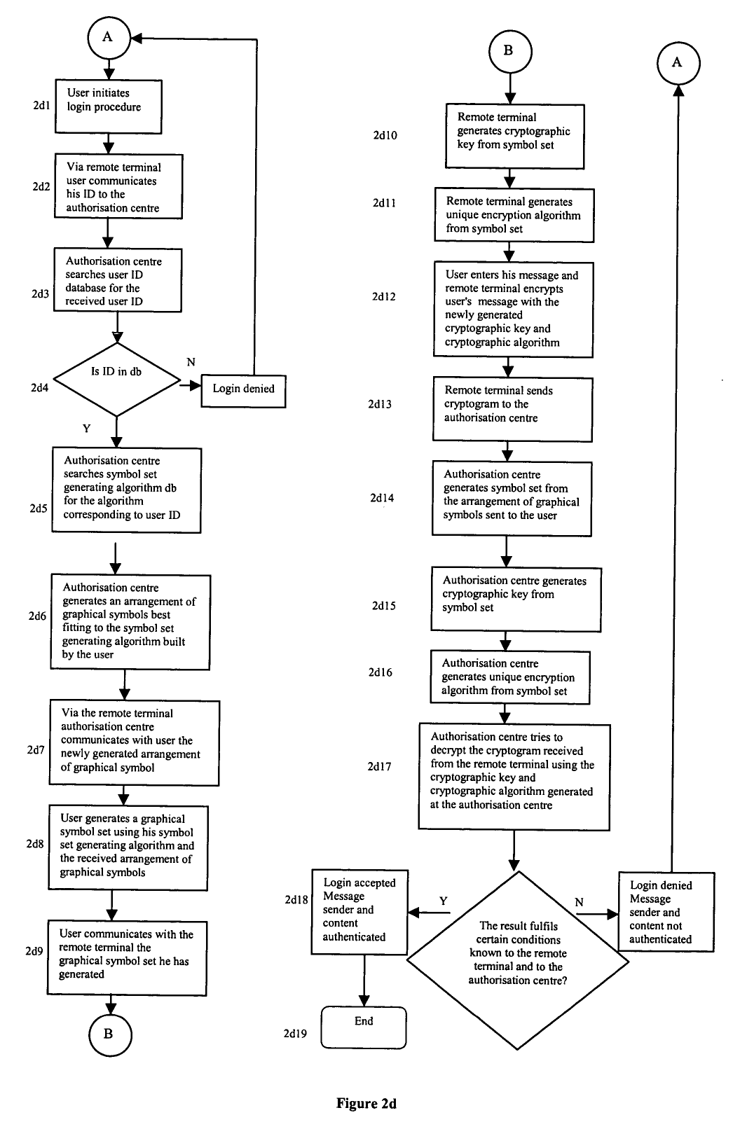

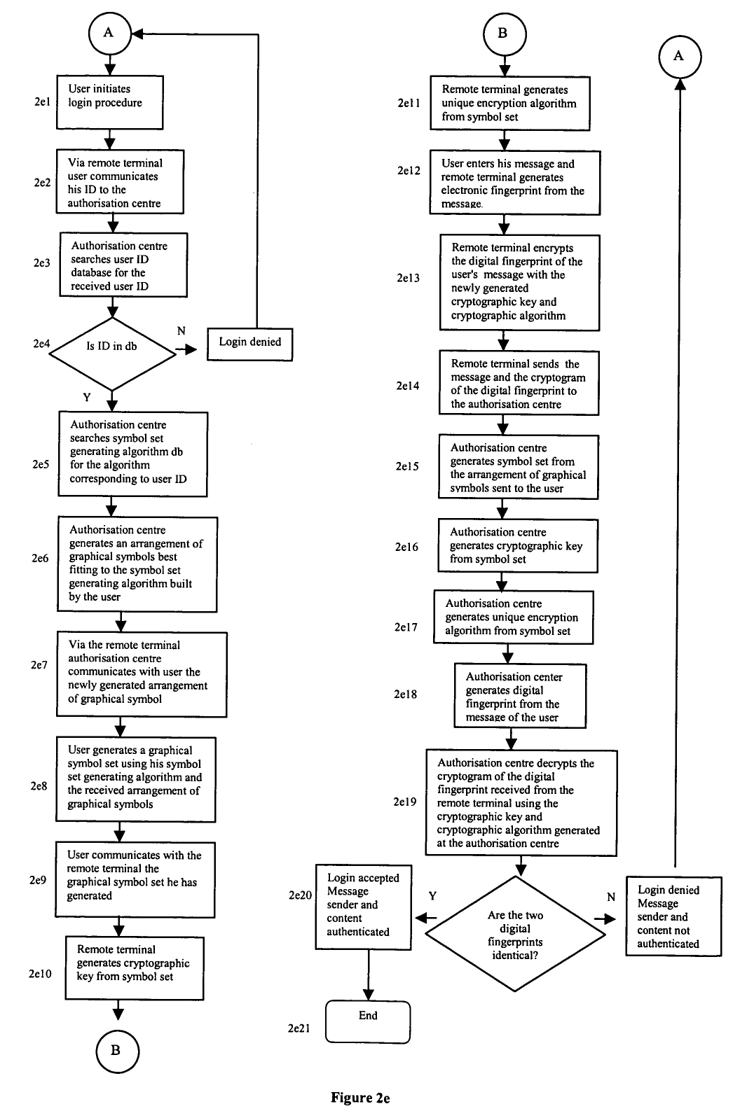

With the explanations given above FIG. 2a shows a flow chart representing the first embodiment of the invention and illustrating how the communication between a user and an authorisation centre is built up required for providing secure access to a limited access system.

The user begins the process in step 2a1 by communicating his wish to access.

In step 2a2 the authorisation centre in response to the request to access generates an arrangement of randomly selected graphical symbols and via the remote terminal communicates it to the user. In steps 2a3 and 2a4 the user uses the randomly selected symbols displayed to him to apply his own unique symbol set generating algorithm and defines (generates) his user ID which is e.g. a character chain and makes the required symbol selection. In doing this he uses the remote terminal and his selection is entered at the same time in the system. In step 2a5 the remote terminal generates a cryptographic key—a multi digit number consisting of a predetermined number of digits—from the set of graphical symbols entered by the user and communicates the key with the authorisation centre. There is a one-to-one correspondence between the selected symbols and the key.

In step 2a6, the authorisation centre searches its user ID database to verify that the entered user ID is valid. In step 2a7, if the user ID is not found in the database, access is denied and the system asks the user to try access again. If the reported ID is found, the authorisation centre continues with step 2a8, and the valid user ID is used to locate the users corresponding symbol set generation algorithm. Based on this algorithm and the arrangement of graphical symbols communicated to the user, in step 2a9 the authorisation centre generates a corresponding symbol set, i.e. the centre performs the same task on the graphical symbols sent to the user as the user did at steps 2a3 and 2a4.

In step 2a10 the authorisation centre generates a cryptographic key from the corresponding symbol set using the same algorithm as the remote terminal did in step 2a5. In step 2a11 the authorisation centre compares the cryptographic key generated by the remote terminal with the corresponding cryptographic key produced in step 2a9. If no matching occurs, the authorisation centre denies access and returns to step 2a1. If a match is detected, the authorisation centre acknowledges access and qualifies the user as an authorised one. Once the authorisation centre has granted access, the access procedure is terminated and the user then may continue with the desired transactions.

In this example the graphical symbol set displayed to the user was sent to the remote terminal before the identification and control of the user's ID. This can impose certain limitation to the user regarding the freedom of selecting any symbol set algorithm. In the second example illustrated by the flow chart of FIG. 2b the order of steps are slightly different.

This version of user's authorisation differs from the previous example in steps 2b2 and 2b6, whereby the authorisation system first receives the user ID of the user and then, instead of generating an arrangement consisting of randomly selected graphical symbols as in step 2a2, the authorisation system generates an arrangement of graphical symbols taking into consideration the best performance of the symbol set generating algorithm assigned to the user ID of the user wishing to gain access. The term “best performance” designates a graphical symbol sets by which the individual symbol set algorithm can be carried out. Really, this can be done easily because after identification the authorisation centre knows the symbol set algorithm selected previously by the user and can generate a set of symbols for display on the screen of the remote terminal, which fits to this selected algorithm. The communication of the user ID in step 2b2 can take place by using and typing in a pre-selected code by the user, or in the same way as in the previous example, i.e. by the selection of two symbols from an initially displayed set of graphical representations. In this embodiment the graphical symbol set displayed to the user in step 2b7 is generally different from the one displayed in step 2b2. In steps 2b8 and 2b9 the user carries out the selection according to his individual selection algorithm. If a higher degree of security is required, this step can be a symbol set selection and modification step, if the user's individual algorithm comprises a modification after the selection. The modification can be very simple, e.g. after the selection of a property in a list, the algorithm can be the use of the immediately next or previous property in the list. By this, the number of possible choices increases by a substantial extent. In step 2b10 a cryptographic key is generated from the selected (e.g. three) symbols. In steps 2b11 and 2b12 the authorisation centre reproduces the symbol set entered by the user by using the user's individual algorithm and applying it on the graphical symbols displayed to the user earlier, and generates the cryptographic key by using the same transformation as it occurred at the remote terminal. In steps 2b13 the two keys are compared, and login is accepted in case of matching keys only.

While in the embodiments shown in the previous two examples the authorisation process was finished by providing access for the authorised user, who then had to send his message of substance to the centre, the embodiment shown in the flow chart of FIG. 2c combines the transmission of the message with the authorisation process. The steps 2c1 to 2c10 are identical with the steps of 2b1 to 2b10, respectively. In step 2c10 the remote terminal generates a cryptographic key—a multi digit number consisting of predefined digits—from the set of graphical symbols entered by the user. In step 2c11 the user enters his message and the remote terminal encrypts the users login message with the newly generated cryptographic key. If necessary, the remote terminal can encrypt the whole message again by using a symmetric key or by a combined public key symmetric key cryptographic method. The actual way of this additional encryption does not form part of the present invention.

In step 2c12 the remote terminal sends the encrypted login message to the authorisation centre. In step 2c13 the authorisation centre—based on the user's symbol set generating algorithm and the arrangement of graphical symbols communicated to the user—generates the corresponding symbol set. In step 2c14 the authorisation centre generates a cryptographic key from the symbol set using the same algorithm as the remote terminal in step 2c10. Upon creating the cryptographic key, in step 2c15 the authorisation centre tries to decrypt the cryptogram of the user's login message received from the remote terminal. If the message is further encrypted with a symmetric key or a combined public key—symmetric key method, the authorisation centre first decrypts the cryptogram with this method, and upon regaining the original cryptogram—encrypted only with the cryptographic key generated from the symbol set of the user—tries to decrypt the message.

In step 2c16 the authorisation centre decides whether the result of the decryption fulfils certain conditions known to the remote terminal and to the authorisation centre (for example the message is written in normal alphanumeric characters or contains a predefined key word, etc.) or not. If the result does not fulfil these conditions, the authorisation centre denies access and continues back to step 2c1. If the result fulfils these conditions, the authorisation centre acknowledges access, and accepts the user as an authorised sender of the whole message. Once the authorisation centre grants access and authenticates the user as the sender of the login message, the authorisation procedure is terminated as indicated by step 2c17. In this embodiment by the end of the authorisation process the message of substance is already available for the authorisation centre. If further communication is required between the user and the centre, the so established encryption method can further be used.

In the fourth embodiment of the invention represented by FIG. 2d not only a unique encryption key is generated from the graphical symbol set generated by the user but also a unique cryptographic algorithm. As most of the different encryption methods belonging to Block Cipher algorithms are—in a simplified way—not more than the repetition of the logical Xor operation, permutation and shift operation on the bits of a block of plain text and/or a block of ciphertext in a particular order, it is relatively easy to generate unique cryptographic algorithms to each different graphical symbol set represented by a certain set of multidigit numbers. For example the number of the repetition of each operation (Xor, permutation, shift) and the parameters of the operation (in which direction the bits of the text are shifted and by how many places, etc.) may be determined by the actual digits being at certain predefined positions of the multidigit numbers representing the graphical symbol set.

According to the above, in step 2d11 the remote terminal generates a unique encryption algorithm from the symbol set generated by the user, while in step 2d16 the authorisation system generates a corresponding encryption algorithm from the graphical symbol set generated by the authorisation system from the arrangement of graphical symbols communicated to the user and in step 2d17 the authorisation system tries to decrypt the cryptogram received from the remote terminal using the cryptographic key and the cryptographic algorithm generated at the authorisation centre. In all other aspects the procedure is done as explained by the description of the previous embodiment.

In the fifth embodiment of the invention represented by FIG. 2e a further way of how to use the basic concept of the invention is represented. In this embodiment not the entire message of the user is encrypted, but a digital fingerprint (message authentication code, MAC) of the message prepared by he remote terminal. The digital fingerprint is encrypted by using the cryptographic key and the cryptographic algorithm generated on the basis of the graphical symbol set generated by the user. When the Authorisation Centre receives the message and the encrypted digital fingerprint of the original message, it may generate the same cryptographic key and algorithm as the user, may decrypt the cryptogram of the digital fingerprint received from the user, may create the digital fingerprint of the message received from the user and may compare the digital fingerprint of the message received and the digital fingerprint received in encrypted form. If the two digital fingerprints are identical, the Authorisation centre may declare the user authorised and the message authentic.

According to the above, in step 2e12 the remote terminal generates a digital fingerprint of the message of the user while in step 2e13 the remote terminal encrypts the digital fingerprint with the encryption key and encryption algorithm generated in steps 2e10 and 2e11. In step 2e18 it encrypts the cryptogram of the digital fingerprint received from the user while in step 2e19 the Authorisation Centre generates the digital fingerprint of the message received from the user. In step 2e20 the Authorisation Centre compares the two digital fingerprints and if they are identical it accepts the user and the message as authenticated otherwise denies the login and does not accept the message as authentic. In all other aspects the procedure is done as explained by the description of the previous embodiment.

The invention provides a highly secure authorisation and user identification system, which is closely associated to the person of the user, it does not require that the user should use any device for carrying out the identification process. No one can learn the user specific symbol selection and/or modification algorithm even after the watching of several transactions. Furthermore, a very reliable and user specific message encryption is provided between the user and the centre. This high degree of reliability allows the use of the Internet as a basic and everywhere available tool of communication. These powerful features are basically the results of the fact that graphic symbols can be remembered easily, and the memorising of a symbol selection algorithm is just as easy.

I claim:

1. Authorisation method for an enrolled user of a limited access system presenting himself at a remote location to obtain access to said system, wherein the system having an authorisation centre and said remote location being provided with a remote terminal connected to the system, characterised by the steps of:
at the time of enrolling said user to said system
assigning an identification code to said user and storing the assigned identification code at the authorisation centre;
assigning a symbol set selection algorithm to said user and storing the assigned symbol set selection algorithm at the authorisation centre in association with the identification code of the user, wherein the symbol set selection algorithm being a list of instructions how a predetermined number of graphic symbols can be generated from a table of graphic symbols, wherein each graphic symbol is characterised by a predetermined number of dominant features and each dominant feature can take a number of values; and
at the time when said user presenting himself at the remote location for obtaining access
displaying for said user on said remote terminal a table of a predetermined number of randomly chosen different graphic symbols so that the user can apply the assigned symbol set algorithm for generating a predetermined number of generated symbols;
forwarding said generated symbols to said authorisation centre;
forwarding said user identification code from the remote terminal to the authorisation centre;
at the authorisation centre using the received identification code and reproducing said generated symbols by using the symbol selection algorithm associated with the identified user and comparing the locally reproduced response symbols with the ones received from the remote terminal, and providing access to said user only if the received and generated symbols being identical.

2. The authorisation method as claimed in claim 1, wherein said user identification code being also a predetermined number of said graphic symbols selectable from said displayed set of graphic symbols.

3. The authorisation method as claimed in claim 1, wherein in said displaying step showing to said user on said remote terminal respective lists associated with each of said features, each list comprising in a consecutive order all variations of the feature concerned, and allowing for said user to select from said lists in association with every generated symbol.

4. The authorisation method as claimed in claim 3, wherein respective features being the shape, the colour and a number written on each of said symbols.

5. The authorisation method as claimed in claim 1, wherein said symbol set generating algorithm comprises selection criteria of features.

6. The authorisation method as claimed in claim 1, wherein said symbol set generating algorithm comprises selection and modification criteria of said features.

7. The authorisation method as claimed in claim 1, further comprising the step of carrying out a transformation on said generated symbols to obtain a longer sequence of characters, defined as cryptographic key, before being forwarded from said remote terminal to said authorisation centre, and in said authorisation centre using the same transformation, and in said comparing step comparing said transformed versions of the generated and reproduced symbols.

8. The authorisation method as claimed in claim 1, wherein in said communication between said remote terminal and said authorisation centre the transmittal of the identification code and the identification of the user at the authorisation centre preceding said displaying step, and in said displaying step constructing said table of graphic symbols in the knowledge of said symbol set generating algorithm associated with the particular user so that said algorithm becomes always applicable.

9. The authorisation method as claimed in claim 8, further comprising the step of carrying out a transformation on said generated symbols to obtain a longer sequence of characters, defined as cryptographic key, before being forwarded from said remote terminal to said authorisation centre, using said cryptographic key for encrypting a message from said user to the authorisation centre, and in said authorisation centre using the same transformation to obtain said cryptographic key, and using said key to decrypt the forwarded information, and in said comparing step decrypting the received information, and the comparison is regarded positive when the decrypted information fulfils certain conditions known to the remote terminal and to the authorisation centre.

10. The authorisation method as claimed in claim 9, further comprising the step of carrying out a transformation on said generated symbols to obtain a longer sequence of characters, defined as cryptographic key and carrying out a still another transformation on said generated symbols to obtain a unique cryptographic algorithm, before being forwarded from said remote terminal to said authorisation centre, using said cryptographic key and said unique cryptographic algorithm for encrypting a message from said user to the authorisation centre, and in said authorisation centre using the same transformation to obtain said cryptographic key and said cryptographic algorithm, and using said key and said algorithm to decrypt the forwarded information, and in said comparing step decrypting the received information, and the comparison is regarded positive when the decrypted information fulfils certain conditions known to the remote terminal and to the authorisation centre.

11. The authorisation method as claimed in claim 10, further comprising the step of creating a digital fingerprint (message authentication code, MAC) from the message of the user with the help of a one way hash function, encrypting the digital fingerprint using the said cryptographic key and unique cryptographic algorithm, forwarding from said remote terminal to said authorisation centre the message and the encrypted digital fingerprint, in said authorisation centre creating a digital fingerprint (message authentication code, MAC) from the message received from the user and using the same transformation to obtain said cryptographic key and said cryptographic algorithm, and using said key and said algorithm to decrypt the digital fingerprint forwarded with the message and in said comparing step decrypting the received digital fingerprint and the comparison is regarded positive when the decrypted digital fingerprint and the digital fingerprint created in the authorisation centre are identical.
